(19) United States
(12) Patent Application Publication
(10) Pub. No.: US 2026/0359869 A1
(43) Pub. Date: Nov. 12, 2026

(54) METHOD FOR PROVIDING VEHICLE REPAIR LABOR ESTIMATES

(71) Applicant: Sheng Ping Wu, Vancouver (CA)

(72) Inventor: Sheng Ping Wu, Vancouver (CA)

(21) Appl. No.: 19/205,115

(22) Filed: May 12, 2025

(51) Int. Cl. G06Q 30/0283; G06Q 10/20

(52) U.S. Cl. CPC G06Q 30/0284; G06Q 10/20

(57) ABSTRACT

A method of providing automobile repair transparency that is operable to provide an owner of a vehicle with component and labor information, including suggested costs, of a repair that is required for a vehicle owned by the user. The method utilizes a software application for creation of vehicle databases, repair history databases and access to repair type database in order to provide a user transparency into the required components and labor for an identified repair. The method includes a step to facilitate searching for a repair either by keyword or category. The software application provides main components, subcomponents and labor required to facilitate completion of an identified repair. The software application further provides tracking and maintenance of repair history for a vehicle stored in the garage database created by the user of vehicle owned thereby.

### FIELD OF THE INVENTION

The present invention relates generally to vehicle repair, more specifically but not by way of limitation, a method facilitated by a software application wherein the present invention provides transparency into automobile repair charges, in particular by providing original equipment manufacturer labor time required to conduct an identified repair.

### BACKGROUND

In today's fast-paced, technology-driven society, transparency in consumer transactions has become both a demand and a necessity. One area that particularly benefits from increased openness is the automotive repair industry, where consumers are often confronted with opaque pricing strategies and inconsistencies in labor time estimates. Developing a software application that provides transparency by offering suggested Original Equipment Manufacturer (OEM) labor times for repairs can play a pivotal role in empowering consumers, fostering industry accountability, and promoting fair pricing practices. At the forefront of the software application's benefits is the empowerment of the consumer. Typically, customers lack the specialized knowledge necessary to verify whether the labor times quoted by auto repair shops are justified. By providing access to standardized OEM labor time data, the application demystifies the repair process, enabling consumers to make more informed decisions about the services they receive. This level of empowerment fosters confidence and allows customers to approach repair negotiations with a clearer understanding of what constitutes a fair charge. Consequently, the application can help mitigate the risk of overcharging, thereby protecting consumers from unnecessary financial burdens.

Transparency in pricing is integral to building trust between service providers and consumers. The proposed software application serves as an impartial resource that bridges the information gap, making the repair process more transparent. By displaying standardized labor times, the application holds auto repair shops accountable for the hours billed during repair services. This level of accountability discourages practices such as inflating labor hours and ensures that service providers adhere to industry standards. Ultimately, when consumers are armed with accurate data, they can challenge discrepancies and demand explanations for any deviations, contributing to a fairer market environment. The introduction of such a software application has the potential to stimulate healthy competition within the automotive repair industry. When consumers are well-informed about OEM labor standards, they are less likely to accept unjustified price inflations, which, in turn, compels repair shops to justify their labor costs and compete based on quality rather than obscured profit margins. As a result, reputable repair facilities that align their billing practices with OEM standards may gain a competitive advantage, encouraging others to follow suit. This dynamic can lead to an overall improvement in service quality and pricing fairness across the industry, benefiting both consumers and conscientious service providers.

Beyond individual consumer savings, the development of this software application can contribute to broader economic efficiencies. By standardizing labor time estimates and ensuring consistency in repair service pricing, the application reduces the likelihood of disputes and potential legal challenges between consumers and repair shops. Furthermore, increased market transparency can reduce the costs associated with information asymmetry, a common inefficiency in many service-based markets. With reduced transaction costs and enhanced market confidence, both consumers and service providers can enjoy a more efficient marketplace where resources are allocated based on fairness and merit. The development of a software application that offers transparency into suggested OEM labor times presents a compelling opportunity to reform the automotive repair industry. By empowering consumers with accurate and accessible information, the application not only protects them from being overcharged but also fosters greater accountability among repair shops. Moreover, as industry standards become more visible and enforced, fair competition is encouraged, ultimately leading to an efficient and equitable marketplace.

Accordingly, there is a need for a software application that facilitates a method that provides a consumer transparency into an amount of time required to facilitate an identified repair wherein the time required is suggested by the manufactured of the automobile.

### SUMMARY OF THE INVENTION

It is the object of the present invention to provide a software application that facilitates a method that provides a transparency into a suggested labor hour requirement to facilitate a repair wherein the present invention includes a step of providing an ability to search by vehicle identification number.

Another object of the present invention is to provide a method that provides transparency into an amount of time required to facilitate a repair on an automobile wherein the present invention includes a step of providing a user an ability to browse repairs by category.

A further object of the present invention is to provide a software application that facilitates a method that provides a transparency into a suggested labor hour requirement to facilitate a repair that further includes a step of maintaining a database of repair history for a vehicle.

Yet a further object of the present invention is to provide a method that provides transparency into an amount of time required to facilitate a repair on an automobile that further includes a step of providing a suggested labor rate and time for a repair.

Still another object of the present invention is to provide a software application that facilitates a method that provides a transparency into a suggested labor hour requirement to facilitate a repair that further includes a step of providing a repair calculator.

An additional object of the present invention is to provide a method that provides transparency into an amount of time required to facilitate a repair on an automobile that further includes a step of providing an ability to search for a repair keyword in the database of the present invention.

Yet a further object of the present invention is to provide a software application that facilitates a method that provides a transparency into a suggested labor hour requirement to facilitate a repair that further includes a step of transferring repair history and searching repair history.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a flowchart of the process of the present invention utilization sequence for identifying and resolving a repair for a vehicle;

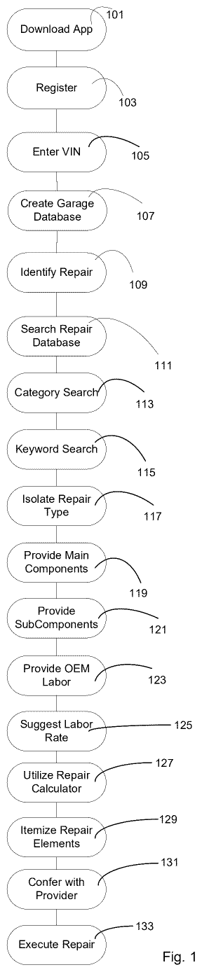

FIG. 2 is a flowchart of the process of the present invention pertaining to maintenance and access of vehicle repair history.

### DETAILED DESCRIPTION

Referring now to the drawings submitted herewith, wherein various elements depicted therein are not necessarily drawn to scale and wherein through the views and figures like elements are referenced with identical reference numerals, there is illustrated a method of providing automobile repair transparency 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the method of providing automobile repair transparency 100 is facilitated by a software application that is operational on conventional computing devices such as but not limited to smart phones and personal computing devices. It should be understood within the scope of the present invention that the present invention further includes database servers operably coupled to the software application that provide the necessary data storage for some of the elements further discussed herein.

In step 101, a user will download the software application of the present invention to a desired computing device. It should be understood within the scope of the present invention that the software application is made available via conventional channels. Step 103, the user will register with the software application creating a specific profile unique to the user. It is contemplated within the scope of the present invention that the user registration includes parameters such as but not limited to user demographic and location information. In step 105, the user will enter the vehicle identification number(VIN) for a vehicle that is currently owned by the user. It should be understood within the scope of the present invention that the user could enter multiple VIN's if the user owns more than one vehicle. Step 107, subsequent entry of at least one VIN, the software application will create a garage database. The garage database is the database that is created to store all information about the vehicle for which the VIN has been entered.

In step 109, the user of the vehicle will identify that a problem exists with the vehicle and a repair needs to be executed. Step 111, ensuing identification of a problem with a vehicle, the user will search the repair database to obtain information about potential components that may be required to facilitate a resolution of the problem with the vehicle. It should be understood within the scope of the present invention that the search of the repair database could be executed utilizing provided category selections or employ utilization of an input keyword as outlined in step 113 and step 115. In step 117, the user will be provided an isolation of the potential repair type from the repair database based upon the keyword or category inputs by the user.

Step 119, the software application provides the user with the main components that may be required to facilitate a repair of the identified problem with the vehicle. These main components can include higher probability parts and costs associated therewith that may be required to facilitate a repair for the identified problem with the vehicle. In step 121, the repair database further provides any subcomponents that may be required during the resolution of the repair. These subcomponents can include items that may have to be replaced during the repair that might not be directly associated with the repair but would have to be replaced during execution of the repair. By way of example but not limitation, if a repair required replacement of an oil cooler than an oil change would be a subcomponent of that repair. Step 123, the repair database provides the original equipment manufacturer suggested labor time required to facilitate the identified repair. This can include any warranty time available based upon the VIN. In step 125, the repair database provides a suggested labor rate for the labor required to facilitate the repair. The labor rate can be an hourly rate and/or total labor rate to complete the identified repair.

Step 127, the user is presented with in the software application a repair calculator. The repair calculator utilizes costs associated with the main components, subcomponents and labor requirements to provide a cost estimate to facilitate resolution of the identified repair. It should be understood within the scope of the present invention that the repair calculator will automatically include adjustments for overlap labor for multiple repairs. By way of example but not limitation, if one part is damage and needs repair and that part must be removed to facilitate and additional repair, no additional labor is included and the labor adjustments are made in the repair calculator. It is contemplated within the scope of the present invention that repairs can be assigned metatags in the repair database of the present invention in order to identify repairs that would be associated and an overlap of labor exists. In step 129, the software application presents to the user and itemized repair list wherein the repair list identifies the component and labor and cost thereof in a single document for the user to review. Step 131, the user will review the repair list with a selected provider that will be performing the repair. The data in the repair list is reviewed between the user and the provider so as to form an agreement therebetween on what components will be required, how much labor is needed and the costs associated therewith. In step 133, the provider will execute the repair on the vehicle.

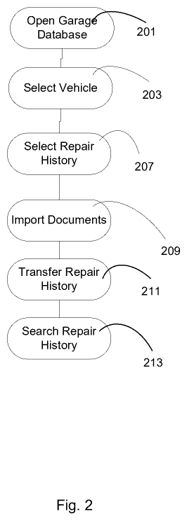

Now referring to FIG. 2 submitted as a part hereof, the user will select the garage database feature in the software application in step 201. Step 203, the user will select the vehicle by VIN number or other identifier provided in the software application that was previously input by the user. In step 205, the user will select a repair history category provided in the software application. Step 207, the user will select add repair invoice. The invoice for a recently performed repair is uploaded into the repair history database of the present invention. The repair history database maintains all repair and service records for the vehicle. It should be understood within the scope of the present invention that the repair history data can be uploaded utilizing suitable techniques such as but not limited to image capture of documents from a smart phone. In step 209, the user will import all documents associated with the most recent repair wherein these documents are stored in the repair history database for the identified vehicle. Step 211, if the user is selling the vehicle, the user can access the repair history database and all of the records associated with the selected vehicle and transfer these documents electronically to another user that is purchasing the vehicle. This transfer of documents could be executed utilizing suitable communication protocols between two portable computing devices wherein both portable computing devices have the software application of the method of providing automobile repair transparency 100. Step 213, a user at any time for a desired reason can access the repair history database and search for a repair history that utilizes parameters such as but not limited to repair type or for a calendar term. It should be understood within the scope of the present invention that the order of the steps of the method of providing automobile repair transparency 100 presented herein are exemplary and do not provide a limitation as to a required order of operation.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method of providing automobile repair transparency wherein the method comprises the steps of:
downloading a software application, wherein the software application is downloaded to a portable computing device;
creating a user profile, wherein a user creates a user profile during a registration process with the software application;
creating a garage database, wherein the garage database provides storage of vehicle information for the user;
entering a vehicle identification number, wherein the user enters a vehicle identification number for a vehicle that is owned by the user, wherein the vehicle is stored in the garage database;
identifying a need for a repair on the vehicle, wherein the user identifies that a repair is needed for the vehicle;
searching a repair database, wherein the user searches the repair database to identify a potential resolution for the repair;
isolating the repair required for the vehicle, wherein the user is provided with information about the repair;
providing main components required to facilitate resolution of the repair, wherein the software application provides main component parts required to facilitate resolution on the repair;
providing an original equipment manufacturer estimate of an amount of labor hours required to perform the repair, wherein the software application displays to the user an amount of time required to complete the repair;
utilizing a repair calculator, wherein the user utilizes a repair calculator to generate an estimate of a cost to complete the repair;
conferring with a service provider, wherein the user confers with a service provider to review the estimate to complete the repair;
performing the repair, wherein the service provider completes the repair on the vehicle.

2. The method of providing automobile repair transparency as recited in claim 1, and further including a step of searching the repair database utilizing a keyword.

3. The method of providing automobile repair transparency as recited in claim 2, and further including a step of searching the repair database by a provided category.

4. The method of providing automobile repair transparency as recited in claim 3, and further including a step of providing a list of subcomponents that may be required to facilitate resolution of the repair.

5. The method of providing automobile repair transparency as recited in claim 4, and further including a step of providing a suggested labor rate and amount of time to complete the repair.

6. The method of providing automobile repair transparency as recited in claim 5, and further including a step of providing an itemized list of main components, subcomponents, labor and prices thereof to the user.

7. The method of providing automobile repair transparency as recited in claim 6, and further including a step of providing a repair history database, wherein the repair history database is accessible via the software application.

8. The method of providing automobile repair transparency as recited in claim 7, and further including a step of uploading repair documents to the repair history database, wherein the user uploads documentation of the repair.

9. The method of providing automobile repair transparency as recited in claim 8, and further including a step of transferring the repair history, wherein the repair history is transferred to another user.

10. The method of providing automobile repair transparency as recited in claim 9, and further including a step of searching the repair history database, wherein the user searches for a specific cataloged repair.

11. The method of providing automobile repair transparency as recited in claim 10, and further including a step of utilizing a portable computing device to record and upload repair documents to the repair database.
